(19) United States
(12) Patent Application Publication
(10) Pub. No.: US 2025/0137720 A1
(43) Pub. Date: May 1, 2025

(54) VERTICAL SMELTING SYSTEM

(71) Applicant: NATIONAL CHENG KUNG UNIVERSITY, Tainan City (TW)

(72) Inventors: Shih-kang LIN, Tainan City (TW); Yu-ning CHIU, Tainan City (TW); Jia-shyan SHIAU, Kaohsiung (TW); Ping-chieh CHENG, Kaohsiung (TW); Ke-miao LU, Kaohsiung (TW)

(21) Appl. No.: 18/929,193

(22) Filed: Oct. 28, 2024

(30) Foreign Application Priority Data
Oct. 31, 2023 (TW) 112141855

(51) Int. Cl. F27B 1/24; F27B 1/20

(52) U.S. Cl. CPC F27B 1/24; F27B 1/20

(57) ABSTRACT

A vertical smelting system is disclosed by the present disclosure. The vertical smelting system comprises a high-temperature heating device, a reaction sample loading device, a reaction product receiving device, a cooling device, and a transmission device. The reaction sample loading device is detachably connected to the high-temperature heating device, and extends downwardly from the high-temperature heating device. The reaction product receiving device located below the reaction sample loading device is detachably connected to the reaction sample loading device. The cooling device is located below the high-temperature heating device. The transmission device respectively connected to the reaction sample loading device and the reaction product receiving device is configured to drive the reaction sample loading device to move relative to the high-temperature heating device, and is further configured to drive the reaction product receiving device to move relative to the reaction sample loading device.

### CROSS-REFERENCE TO RELATED APPLICATION

This application claims the benefit of Taiwan Patent Application No. 112141855, filed on Oct. 31, 2023, which is hereby incorporated by reference in its entirety herein.

### FIELD OF INVENTION

The present disclosure relates to a smelting system, and in particular to a vertical smelting system.

### BACKGROUND OF INVENTION

For conventional high-temperature smelting furnaces, in order to obtain information, such as softening and shrinkage rate of mineral materials, gas permeability, and melting temperatures of slag phases under realistic on-site ironmaking conditions, it is often necessary to consider a weight of material particles caused by stacking of mineral materials. Therefore, design of a furnace body is usually vertical. Moreover, devices such as load and pressurization devices, softening deformation displacement meters, and gas differential pressure meters are equipped above the furnace body to indirectly and qualitatively record high-temperature change morphology of a smelting process by defining appropriate physical and chemical indicators, such as softening temperature, which is often defined as a temperature at which change of volumetric shrinkage of iron ore is greater than 5% (measured using a displacement meter). However, since an exterior of the furnace body of the vertical high-temperature smelting furnace is covered by insulation material, the reaction inside a crucible usually cannot be directly observed. Moreover, the crucible needs to be cooled for most of the day, which not only wastes time but also hinders direct observation and research of material morphology changes during reaction processes.

Moreover, in addition to the vertical furnace bodies, there are also some horizontal high-temperature smelting furnaces. A horizontal high-temperature smelting furnace is equipped with a charge-coupled device (CCD) camera in the horizontal direction to monitor high-temperature morphology changes of materials and rapid cooling to help understand high-temperature smelting. For example, the softening temperature is often defined as a temperature at which change of volumetric shrinkage of iron ore is greater than 5%, which is obtained by monitoring changes in iron ore profile using CCD camera. However, it is difficult to equip a load and pressurization device on the furnace body due to the horizontal design, so that an effect of simulating bearing weight of mineral material stacks cannot be achieved. Therefore, an airflow reaction of real metal smelting is unable to be closely simulated, which greatly affects the high-temperature softening morphology, so that the data obtained in this way lack the value of direct comparison and reference.

In summary, the conventional high-temperature smelting furnace needs to be improved.

### SUMMARY OF INVENTION

### Technical Problems

A main purpose of the present disclosure is to provide a vertical smelting system to solve a technical problem of inability to quickly cool high-temperature experimental samples, as well as a technical problem of difficulty in clarifying a reaction progress path under continuous reactions of slag phases during a smelting process.

### Technical Solutions

In order to achieve the foregoing purpose of the present disclosure, the present disclosure provides a vertical smelting system used in metal smelting, including iron smelting, aluminum smelting, copper smelting, and hydrogen metallurgy processes, comprising: a high-temperature heating device configured to heat a reaction sample; a reaction sample loading device detachably connected to the high-temperature heating device, and extending downwardly from the high-temperature heating device, wherein a bottom of the reaction sample loading device possesses a hole, and the reaction sample loading device is configured to load the reaction sample; a reaction product receiving device detachably connected to the reaction sample loading device and located below the reaction sample loading device, wherein the reaction product receiving device is configured to receive a reaction product obtained from heating the reaction sample; a cooling device located below the high-temperature heating device, and configured to cool the reaction sample or the reaction product; and a transmission device respectively connected to the reaction sample loading device and the reaction product receiving device, configured to drive the reaction sample loading device to move relative to the high-temperature heating device, and further configured to drive the reaction product receiving device to move relative to the reaction sample loading device.

In one embodiment of the present disclosure, the transmission device includes a first transmission element and a second transmission element, the first transmission element is connected to the reaction sample loading device and is configured to drive the reaction sample loading device to move relative to the high-temperature heating device, and the second transmission element is connected to the reaction product receiving device and is configured to drive the reaction product receiving device to move relative to the reaction sample loading device.

In one embodiment of the present disclosure, the first transmission element is configured to drive the reaction sample loading device to move vertically relative to the high-temperature heating device.

In one embodiment of the present disclosure, the first transmission element includes a first guide and a first sliding block, the first sliding block is slidably disposed on the first guide, the first sliding block is connected to the reaction sample loading device, and the reaction sample loading device moves in a vertical direction by sliding the first sliding block along the first guide.

In one embodiment of the present disclosure, the second transmission element is configured to drive the reaction product receiving device to move horizontally relative to the reaction sample loading device.

In one embodiment of the present disclosure, the second transmission element includes a second guide, a second sliding block, and a second carrier, the second sliding block is slidably disposed on the second guide, the reaction product receiving device is disposed on the second carrier which is connected to the second sliding block, and the reaction product receiving device moves in a horizontal direction by sliding the second sliding block along the second guide.

In one embodiment of the present disclosure, the transmission device is configured to drive the reaction sample loading device to move from a heating position to a cooling position, the heating position is adjacent to the high-temperature heating device, and the cooling position is adjacent to the cooling device.

In one embodiment of the present disclosure, the cooling device is a gas cooling device.

In one embodiment of the present disclosure, the reaction sample loading device is a tubular device, one end of the reaction sample loading device is detachably connected to the high-temperature heating device, and the other end of the reaction sample loading device is detachably connected to the reaction product receiving device.

In one embodiment of the present disclosure, the reaction product receiving device possesses a main container and a plurality of reaction product collecting units, and the plurality of reaction product collecting units are disposed in the main container.

### Beneficial Effects

First, all the functions of conventional vertical smelting furnace devices are retained by the vertical smelting system of the present disclosure. Further, the reaction sample loading device leaves the high-temperature heating device for the cooling device at any time by the transmission device for rapid gas quenching during smelting experiments by the detachable connection among the high-temperature heating device, the reaction sample loading device, and the reaction product receiving device. In addition to rapidly cooling high-temperature reaction samples, the slags in different slag phases generated during different reactions can also be separated, cooled, and collected, thereby achieving a technical effect of independent analysis of the slag phases in the early, middle, and final stages of smelting. Accordingly, a reaction progress path of the continuous reactions of the slag phases during the smelting process can be clarified.

### DESCRIPTION OF DRAWINGS

In order to more clearly illustrate the above contents of the present disclosure, the following is a detailed description of the preferred embodiments with reference to the accompanying drawings:

FIG. 1 is a schematic diagram of a vertical smelting system according to an embodiment of the present disclosure.

FIG. 2 is another schematic diagram of a vertical smelting system according to an embodiment of the present disclosure.

FIG. 3 is a schematic diagram of a reaction product receiving device of the vertical smelting system according to an embodiment of the present disclosure.

FIG. 4A is a schematic diagram of a first transmission element of the vertical smelting system according to an embodiment of the present disclosure.

FIG. 4B is another schematic diagram of a first transmission element of the vertical smelting system according to an embodiment of the present disclosure.

FIG. 5 is a schematic diagram of a second transmission element of the vertical smelting system according to an embodiment of the present disclosure.

FIG. 6 is a schematic diagram of a third transmission element of the vertical smelting system according to an embodiment of the present disclosure.

### DETAILED DESCRIPTION OF PREFERRED EMBODIMENTS

In order to describe the technical solutions of the present disclosure more clearly, numerous specific details are provided in the following specific embodiments with reference to the accompanying drawings. Apparently, the present disclosure can be practiced without certain specific details.

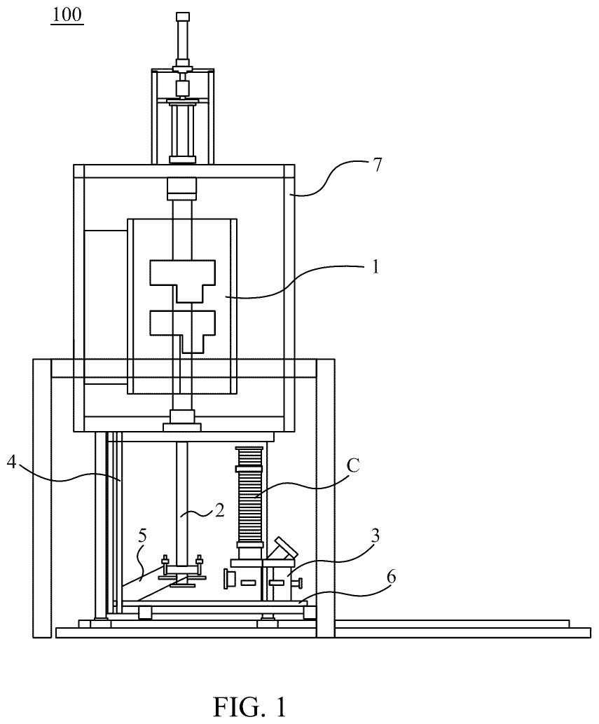

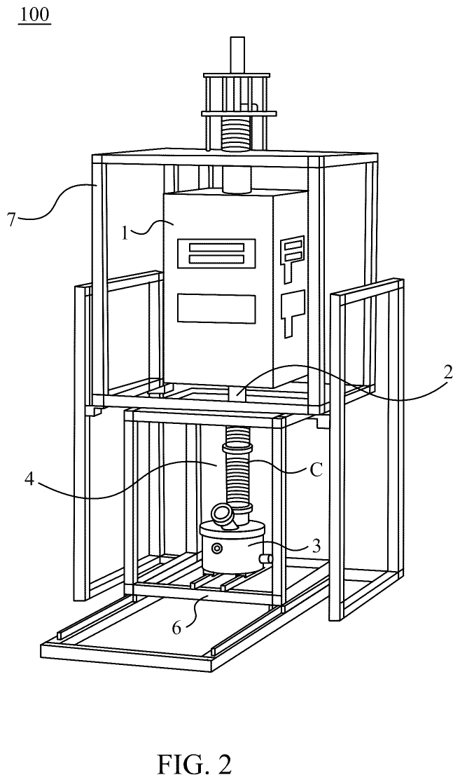

Refer to FIG. 1 and FIG. 2. A vertical smelting system 100 according to an embodiment of the present disclosure comprises: a high-temperature heating device 1, a reaction sample loading device 2, a reaction product receiving device 3, and a cooling device 4.

The reaction sample loading device 2 is used to load a reaction sample. In the present embodiment, the reaction sample loading device 2 is a crucible having a tubular structure of which an inner diameter can range from 50 to 60 mm, such as 50, 51, 52, 53, 54, 55, 56, 57, 58, 59, or 60 mm, and a height can range from 15 to 30 cm, such as 15, 20, 25, or 30 cm. One end of the crucible is detachably connected to the high-temperature heating device 1 and extends downward from the high-temperature heating device 1. A bottom of the crucible has a hole 21. A reaction product obtained by heating the reaction sample by the high-temperature heating device 1 can fall into the reaction product receiving device 3 through the hole and be collected by the reaction product receiving device 3.

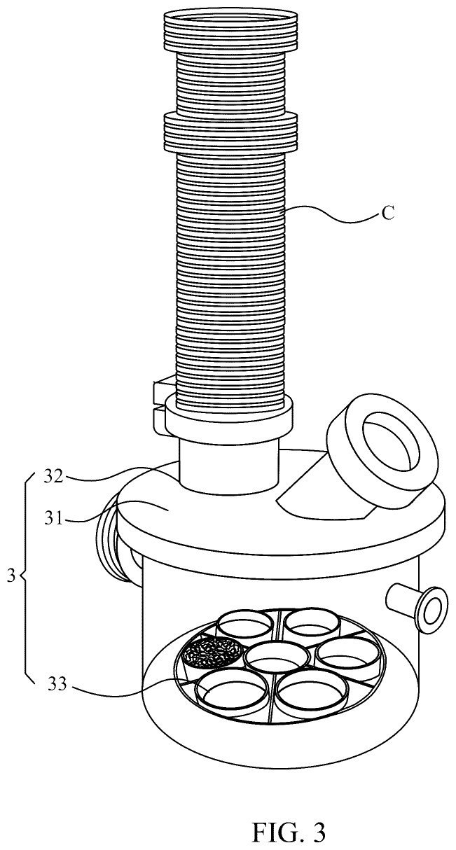

Refer to FIG. 1 to FIG. 3. The reaction product receiving device 3 is located below the reaction sample loading device 2, and has a main container 31, an inlet 32, and six reaction product collecting units 33. The inlet 32 is formed on the top of the main container 31 and is connected to an interior of the main container 31. The six reaction product collecting units 32 are disposed in a circular manner in the main container 31 for receiving the reaction product, and one of the six reaction product collecting units 32 can be aligned and connected to the inlet 32 by rotation. The reaction product receiving device 3 is detachably connected to the other end of the reaction sample loading device 2 through one end of a hollow connecting unit C. The other end of the hollow connecting unit C is connected to the inlet 32 and is aligned and connected to one of the six reaction product collecting units 32. Certainly, a number of the reaction product collecting units of the present disclosure is not limited to 6. In other embodiments, the number of the reaction product connecting units may be adjusted according to different situations, such as a temperature range for collection, and a configuration method thereof is not limited to circular.

Refer to FIG. 1 and FIG. 2. The cooling device 4 is located below the high-temperature heating device 1. The cooling device 4 may be a gas rapid cooling device that achieves an effect of rapid cooling by discharging cooling gas at a rate greater than 150° C./min, such as 150, 155, 160, 165, 170, 175, or 180° C./min.

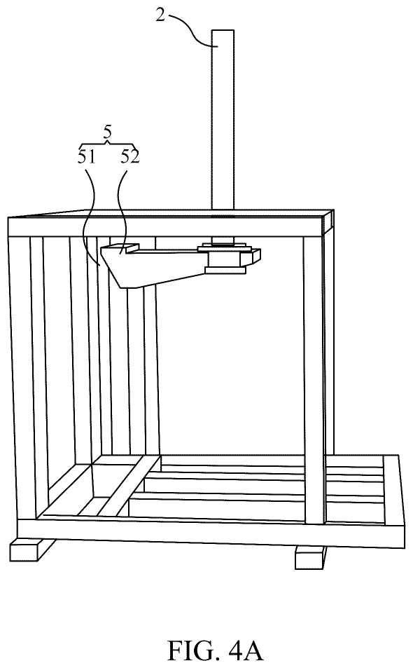

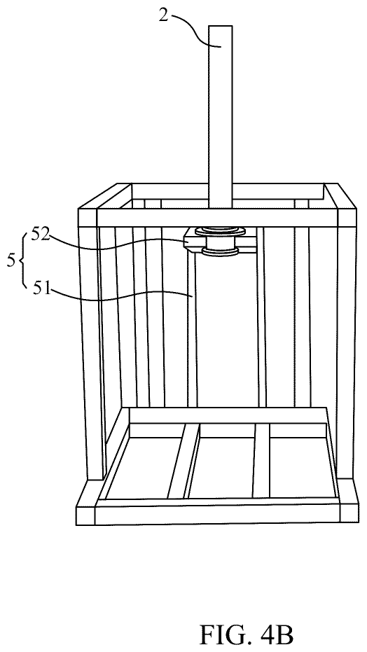

Refer to FIG. 1 and FIG. 2. The transmission device is connected to the reaction sample loading device 2 and the reaction product receiving device 3, respectively, and is used to drive the reaction sample loading device 2 to move relative to the high-temperature heating device 1 and used to drive the reaction product receiving device 3 to move relative to the reaction sample loading device 2. Specifically, the transmission device includes a first transmission element 5 and a second transmission element 6. The first transmission element 5 is connected to the reaction sample loading device 2 and is used to drive the reaction sample loading device 2 to vertically move between the high-temperature heating device 1 and the cooling device 4. Refer to FIG. 4A and FIG. 4B. Furthermore, the first transmission element 5 is a pneumatic guide and includes a first guide 51 and a first sliding block 52. The first sliding block 52 is slidably disposed on the first guide, and the first sliding block 52 is connected to the end of the reaction sample loading device 2. The first sliding block 52 slides in a vertical direction along the first guide 51 to drive the reaction sample loading device 2 moves in the vertical direction.

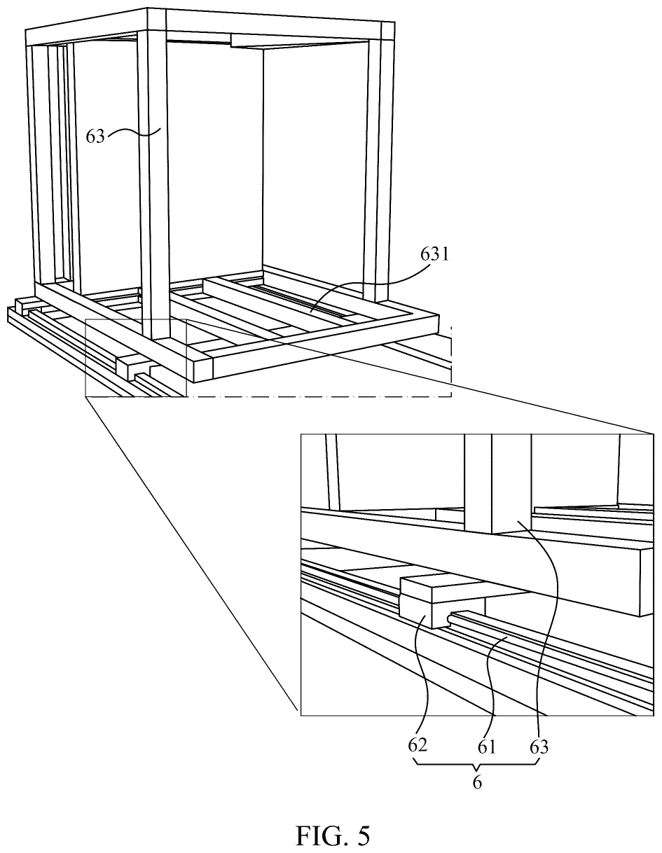

The second transmission element 6 is connected to the reaction product receiving device 3 and is used to drive the reaction product receiving device 3 to move horizontally between being connected to or not connected with the reaction sample loading device 2. Refer to FIG. 5. Further, the second transmission element 6 is a pneumatic guide, and includes a second guide 61, a second sliding block 62, and a second carrier 63. The second sliding block 62 is slidably disposed on the second guide 61, and the second carrier 63 is generally a rectangular frame with a hollow bottom. A second carrier bracket 631 is disposed on a bottom of the second carrier 63 and is approximately located in the middle of the bottom of the second carrier 63, and the reaction product receiving device 3 is disposed on the second carrier bracket 631. The bottom of the second carrier 63 is connected to the second sliding block 62. The second sliding block 62 slides along the second guide 61 in a horizontal direction, thereby driving the reaction product receiving device 3 to move in the horizontal direction.

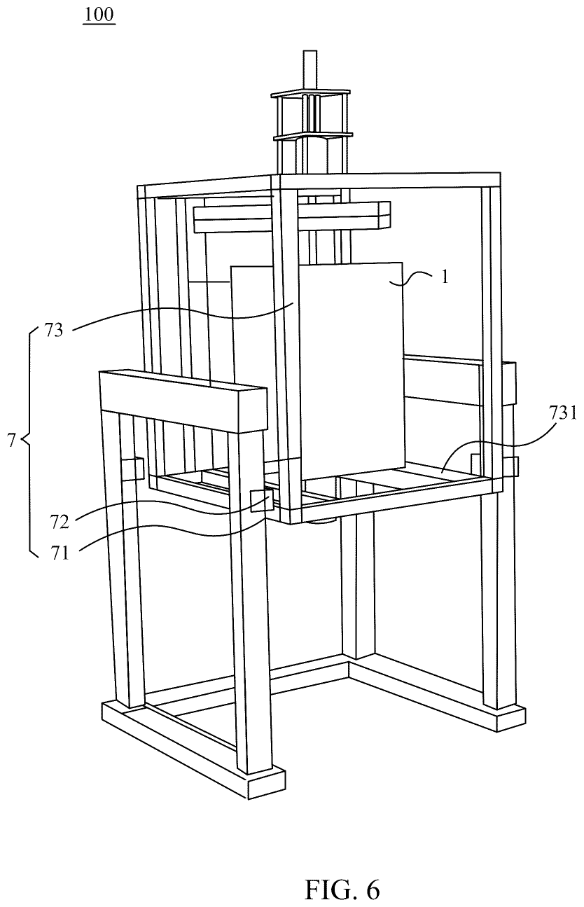

Refer to FIG. 6. Optionally, the transmission device may further include a third transmission element 7 which is connected to the high-temperature heating device 1 and is used to move the high-temperature heating device 1 in the vertical direction. The third transmission element 7 is a pneumatic guide and includes a third guide 71, a third sliding block 72, and a third carrier 73. The third sliding block 72 is slidably disposed on the third guide 71. The third carrier 73 is generally a rectangular frame with a hollow bottom. A third carrier bracket 731 is disposed on a bottom of the third carrier 73 and is approximately located in the middle of the bottom of the third carrier 73. The high-temperature heating device 1 is disposed on the third carrier bracket 731. A side of the third carrier 73 is connected to the third sliding block 72, and the third sliding block 72 slides in the vertical direction along the third guide 71, thereby driving the high-temperature heating device 1 to move in the vertical direction, so as to facilitate a maintenance and component replacement of the high-temperature heating device 1.

A method of using the vertical smelting system of the present disclosure to perform metal smelting is substantially described as follows. A reaction sample is put into the reaction sample loading device 2. The reaction sample loading device 2 is connected to the high-temperature heating device 1 through the transmission device to heat the reaction sample through the high-temperature heating device 1, and the reaction sample loading device 2 is connected to the reaction product receiving device 3 which is below the reaction sample loading device 2. In other word, during the heating of the reaction sample, the high-temperature heating device 1, the reaction sample loading device 2, and the reaction product receiving device 3 are connected to each other. The reaction product (liquid substance) produced by heating the reaction sample falls from the hole of the bottom of the reaction sample loading device 2 to a reaction product collecting unit 33 connected with the reaction sample loading device 2, and the reaction products can be collected in multiple temperature ranges in the different reaction product collecting units 33 by connecting another reaction product collecting unit 33 to the reaction sample loading device 2 by rotating the reaction product receiving device 3. Further, at any time point or at the end of the smelting process, the reaction sample loading device 2 can leave the high-temperature heating device 1 downward through the first transmission element 5 and move to the cooling device 4 for cooling. Optionally, a cooling temperature is below a melting point. A method of the reaction sample loading device 2 moving to the cooling device 4 comprises the following steps. First, the reaction product receiving device 3 releases the connection with the reaction sample loading device 2 and moves horizontally away from one side of the cooling device 1 through the second transmission element 6. Then, the reaction sample loading device 2 descends downward through the first transmission element 5 to the vicinity of the cooling device 4. The cooling device 4 can cool the entire reaction sample loading device 2. For example, the cooling device 4 can cool the entire reaction sample loading device 2 by spraying of cooling gas.

Reference is now made to the following examples, which together with the above descriptions, illustrate use of the vertical smelting system of the present disclosure for metal smelting and data analysis in a non-limiting fashion. It should be apparent to those skilled in the art that various changes and modifications of the embodiments described herein may be made without departing from the scope and spirit of the present disclosure.

### EXAMPLE

### Ironmaking:

Reaction samples were placed in a stacked manner into the reaction sample loading device. The reaction samples mainly included iron ore and coke. The iron ore may be hematite (Fe₂O₃), magnetite (Fe₃O₄), and/or wüstite (FeO), and contains oxides, such as silicon, aluminum, and calcium. The stacking method was performed by sandwiching the iron ore between two layers of the coke.

The process conditions are shown as follows and Table 1:

In order to simulate a practical blast furnace ironmaking process, the following three types of parameters were provided. In the first parameter, a temperature ranged from 250 to 900° C., and 9 L/min of N₂, 3.75 L/min of CO, and 2.25 L/min of CO₂ were introduced at a stable heating rate (10° C./min). In the second parameter, a temperature ranged from 900 to 1200° C., and 9 L/min of N₂ and 6 L/min of CO were introduced at a stable heating rate (2° C./min). In the third parameter, a temperature ranged from 1200 to 1600° C., and 9 L/min of N₂ and 6 L/min of CO were introduced at a stable heating rate (5° C./min).

TABLE 1
Process parameter setting

| Temperature | heating rate | CO | CO₂ | N₂ |
|---|---|---|---|---|
| (° C.) | (° C./min) | (l/min) | (l/min) | (l/min) |
| 250-900 | 10 | 3.75 | 2.25 | 9 |
| 900-1200 | 2 | 6 | 0 | 9 |
| 1200-1600 | 5 | 6 | 0 | 9 |

6 of reaction product collecting units were used to collect reaction products in six temperature ranges of 1000 to 1100° C., 1100° C. to 1200° C., 1200 to 1300° C., 1300° C. to 1400° C., 1400° C. to 1500° C., and 1500° C. to 1600° C., respectively.

After the collection for the reaction product at 1600° C. ended, the reaction sample loading device was moved to the cooling device by the transmission device for cooling. A temperature of the reaction sample in the reaction sample loading device should be lowered to below 1000° C. for solidification within 4 minutes after the experiment ended, and the reaction product receiving device was physically translated by the transmission device and taken out individually. After that, the 6 of reaction product collecting units were taken out one by one, and the reaction products in the 6 of reaction product collecting units were taken out and weighed individually afterwards.

### Experimental Data Analysis and Results:

Chemical compositions of the reaction sample were used to calculate. Total amounts of molten iron and slag could be theoretically obtained by the reaction samples are shown as follows.

$$m 0 = w 0 \times \{ [ T Fe ] + [ {SiO}_{2} ] + [ MgO ] + [ CaO ] + [ {Al}_{2} {O}_{3} ] \}$$

m0: total amounts of molten iron and slag
w0: a weight of the reaction sample
[TFe]: TFe content of the sample

The following data are indicators of a reaction of iron ore into molten iron.

### (1) Meltdown Ratio of Molten Iron:

$$Meltdown ratio = md / m 0$$

### (2) Softening Temperature Ts:

A temperature with a gas pressure difference larger than 100 mm H₂O and closest to 100 mm H₂O was taken.

### Melting Temperature TM:

A temperature corresponding to when a height of the sample almost stops changing was taken. For every 1° C. increased in a test temperature, a height of the sample was less than 0.02 mm.

### Gas Permeability Resistance (S-Value):

An integration of gas pressure difference versus temperature between Ts and Tm.

### High-Temperature Gas Permeability Resistance (S-Value):

An integration of gas pressure difference versus temperature during 1560° C. and 1580° C.

The results are shown as follows in Table 2:

TABLE 2
Reaction products (slag phase collected in the
early, middle, and final stages of smelting)

| Temperature | Empty | Total weight | Net weight | |
|---|---|---|---|---|
| (° C.) | weight (g) | (g) | (g) | Condition |
| 1000-1100 | 111.23 | 112.51 | 1.28 | Non-obvious |
| | | | | meltdown |
| 1100-1200 | 113.55 | 114.23 | 0.68 | Non-obvious |
| | | | | meltdown |
| 1200-1300 | 114.31 | 116.34 | 2.03 | No obvious |
| | | | | meltdown |
| 1300-1400 | 110.61 | 111.2 | 0.59 | No obvious |
| | | | | meltdown |
| 1400-1500 | 113.23 | 127.76 | 14.53 | A little |
| | | | | meltdown |
| 1500-1600 | 115.24 | 287.89 | 172.65 | Obvious |
| | | | | meltdown |
| | | | | and partial |
| | | | | spilling |

| | |
|---|---|
| Total weight of crucible before | 885 |
| experiment (g) | |
| Total weight of crucible after | 654 |
| experiment (g) | |
| Total amount of dripping (g) | 231 |
| Total amount of iron slag (g) | 191.76 |
| Meltdown ratio (%) | 76.7% |
| Softening temperature (Ts) | 1453° C. |
| Melting temperature (Tm) | 1526° C. |
| Gas permeability resistance (S-value) | 147 mm H₂O |
| High-temperature gas permeability | 203 mm H₂O |
| resistance (S-value) | |

As mentioned above, all the functions of conventional vertical smelting furnace devices are retained by the vertical smelting system of the present disclosure. Further, the reaction sample loading device leaves the high-temperature heating device for the cooling device at any time by the transmission device for rapid gas quenching during smelting experiments by the detachable connection among the high-temperature heating device, the reaction sample loading device, and the reaction product receiving device. In addition to rapidly cooling high-temperature reaction samples, the slags in different slags phases generated during different reactions can also be separated, cooled, and collected, thereby achieving a technical effect of independent analysis of the slag phases in the early, middle, and final stages of smelting. Accordingly, a reaction progress path of the continuous reactions of the slag phases during the smelting process can be clarified. While the preferred embodiments of the present disclosure have been described above, it will be recognized and understood that various changes and modifications can be made, and the appended claims are intended to cover all such changes and modifications which may fall within the spirit and scope of the present disclosure.

What is claimed is:

1. A vertical smelting system, comprises:
a high-temperature heating device configured to heat a reaction sample;
a reaction sample loading device detachably connected to the high-temperature heating device, and extending downwardly from the high-temperature heating device, wherein a bottom of the reaction sample loading device possesses a hole, and the reaction sample loading device is configured to load the reaction sample;
a reaction product receiving device detachably connected to the reaction sample loading device and located below the reaction sample loading device, wherein the reaction product receiving device is configured to receive a reaction product obtained from heating the reaction sample;
a cooling device located below the high-temperature heating device, and configured to cool the reaction sample or the reaction product; and
a transmission device respectively connected to the reaction sample loading device and the reaction product receiving device, configured to drive the reaction sample loading device to move relative to the high-temperature heating device, and further configured to drive the reaction product receiving device to move relative to the reaction sample loading device.

2. The vertical smelting system as claimed in claim 1, wherein the transmission device includes a first transmission element and a second transmission element, the first transmission element is connected to the reaction sample loading device and is configured to drive the reaction sample loading device to move relative to the high-temperature heating device, and the second transmission element is connected to the reaction product receiving device and is configured to drive the reaction product receiving device to move relative to the reaction sample loading device.

3. The vertical smelting system as claimed in claim 2, wherein the first transmission element is configured to drive the reaction sample loading device to move vertically relative to the high-temperature heating device.

4. The vertical smelting system as claimed in claim 3, wherein the first transmission element includes a first guide and a first sliding block, the first sliding block is slidably disposed on the first guide, the first sliding block is connected to the reaction sample loading device, and the reaction sample loading device moves in a vertical direction by sliding the first sliding block along the first guide.

5. The vertical smelting system as claimed in claim 2, wherein the second transmission element is configured to drive the reaction product receiving device to move horizontally relative to the reaction sample loading device.

6. The vertical smelting system as claimed in claim 5, wherein the second transmission element includes a second guide, a second sliding block, and a second carrier, the second sliding block is slidably disposed on the second guide, the reaction product receiving device is disposed on the second carrier which is connected to the second sliding block, and the reaction product receiving device moves in a horizontal direction by sliding the second sliding block along the second guide.

7. The vertical smelting system as claimed in claim 1, wherein the transmission device is configured to drive the reaction sample loading device to move from a heating position to a cooling position, the heating position is adjacent to the high-temperature heating device, and the cooling position is adjacent to the cooling device.

8. The vertical smelting system as claimed in claim 1, wherein the cooling device is a gas cooling device.

9. The vertical smelting system as claimed in claim 1, wherein the reaction sample loading device is a tubular device, one end of the reaction sample loading device is detachably connected to the high-temperature heating device, and the other end of the reaction sample loading device is detachably connected to the reaction product receiving device.

10. The vertical smelting system as claimed in claim 1, wherein the reaction product receiving device possesses a main container and a plurality of reaction product collecting units, and the plurality of reaction product collecting units are disposed in the main container.
